(19) United States
(12) Patent Application Publication
(10) Pub. No.: US 2026/0316772 A1
(43) Pub. Date: Oct. 15, 2026

(54) VEHICLE CONTROL APPARATUS

(71) Applicant: TOYOTA JIDOSHA KABUSHIKI KAISHA, Toyota-shi (JP)

(72) Inventors: Toshifumi KAWASAKI, Nagakute-shi (JP); Keisuke NAKAJIMA, Toyota-shi (JP)

(73) Assignee: TOYOTA JIDOSHA KABUSHIKI KAISHA, Toyota-shi (JP)

(21) Appl. No.: 19/465,081

(22) Filed: Jan. 30, 2026

(30) Foreign Application Priority Data
Feb. 3, 2025 (JP) 2025-015994

(51) Int. Cl. B60W 50/08; B60W 30/09

(52) U.S. Cl. CPC B60W 50/087; B60W 30/09; B60W 2540/10; B60W 2540/16; B60W 2556/10; B60W 2720/106

(57) ABSTRACT

A vehicle control apparatus executes an acceleration suppression control for suppressing acceleration of a vehicle when both a history condition and an object condition are satisfied. The history condition is satisfied when at least one of an execution history and an operation history is stored. The execution history represents that a collision risk reduction control was executed during an erroneous operation determination period. The operation history represents that the number of times a driver operated a shift lever during the erroneous operation determination period is equal to or greater than a threshold number. The object condition is satisfied when an object is present in a predetermined area in a traveling direction of the vehicle.

### TECHNICAL FIELD

The present disclosure relates to a vehicle control apparatus that executes a collision risk reduction control for reducing a collision risk, when a target object having a high collision risk of colliding with a vehicle is present in a traveling direction of the vehicle.

### BACKGROUND

Conventionally, a vehicle control apparatus that executes a collision risk reduction control for reducing a collision risk has been known. As one example, the collision risk reduction control is an automatic braking control for decelerating a vehicle without requiring a braking operation by a driver. For example, a vehicle control apparatus described in Patent Document 1 (hereinafter referred to as "the conventional apparatus") executes an accelerator override for canceling the collision risk reduction control when an accelerator operation by the driver satisfies a predetermined override condition during execution of the collision risk reduction control. Furthermore, the conventional apparatus does not execute the accelerator override when the accelerator operation is an erroneous operation, even if the accelerator operation satisfies the override condition.

Patent Document 1: Japanese Patent Application Laid-Open No. 2024-051359

### SUMMARY

When the accelerator operation is the erroneous operation, the vehicle is likely to rapidly accelerate. Rapid acceleration of the vehicle makes posture of the vehicle unstable. When the posture of the vehicle becomes unstable, it becomes difficult to detect an object present in a traveling direction of the vehicle. As a result, the rapid acceleration of the vehicle increases a possibility that the collision risk reduction control is not appropriately executed. Therefore, in order to prevent the rapid acceleration of the vehicle, it is desirable that an acceleration suppression control for suppressing acceleration of the vehicle be executed. However, if the accelerator operation is not the erroneous operation, the acceleration suppression control increases a possibility that the driver feels discomfort with the acceleration suppression control.

The present disclosure is made to address the above problem. That is, one of the objects of the present disclosure is to provide a vehicle control apparatus that increases the possibility of appropriately executing the collision risk reduction control by executing the acceleration suppression control, and reduces the possibility that the driver feels discomfort with the acceleration suppression control.

A vehicle control apparatus according to the present disclosure (hereinafter referred to as "the present apparatus") executes a collision risk reduction control for reducing a collision risk, when a target object having a high collision risk of colliding with a vehicle is present in a traveling direction of the vehicle (step 315: "Yes", step 330, step 610).

The vehicle control apparatus is configured to:
execute an accelerator override that cancels the collision risk reduction control (step 355) when an accelerator operation by a driver satisfies a predetermined override condition during execution of the collision risk reduction control (step 345: "Yes");
determine that the accelerator operation is an erroneous operation when the accelerator operation satisfies a predetermined erroneous operation condition;
not execute the accelerator override even if the accelerator operation satisfies the override condition during an erroneous operation determination period representing a period during which the accelerator operation is determined to be the erroneous operation (step 340: "Yes"); and
execute an acceleration suppression control for suppressing acceleration of the vehicle (step 525, step 615 to step 625) when both a history condition and an object condition are satisfied (step 515: "Yes", step 520: "Yes"),

wherein, the history condition is satisfied when at least one of an execution history representing that the collision risk reduction control was executed during the erroneous operation determination period and an operation history representing that the number of times the driver operated a shift lever during the erroneous operation determination period is equal to or greater than a threshold number is stored,

wherein, the object condition is satisfied when an object is present in a predetermined area in the traveling direction.

In a case where at least one of the execution history and the operation history is stored, there is high possibility that the driver was a panic state when the accelerator operation was the erroneous operation. Such a driver is more likely to cause the vehicle to rapidly accelerate when the accelerator pedal is erroneously operated. Accordingly, when both the history condition and the object condition are satisfied, the present apparatus executes the acceleration suppression control. The acceleration suppression control can suppress the acceleration, even if the driver causes the vehicle to rapidly accelerate. As a result, the present apparatus can prevent a situation in which an object becomes difficult to be detected due to the rapid acceleration. If the collision risk is increased, the present apparatus can increase the possibility that the collision risk reduction control is appropriately executed. Furthermore, if the history condition is not satisfied, the acceleration suppression control is not executed, and therefore, the present apparatus can reduce the possibility that the driver feels uncomfortable with the acceleration suppression control.

### BRIEF DESCRIPTION OF THE DRAWINGS

FIG. 1 is a schematic system configuration diagram of a vehicle control apparatus according to an embodiment of the present disclosure.

FIG. 2 is an explanatory diagram illustrating an example of operation of the vehicle control apparatus according to the embodiment of the present disclosure.

FIG. 3 is a flowchart illustrating a collision risk reduction control routine executed by a CPU of an ECU shown in FIG. 1.

FIG. 4 is a flowchart illustrating an operation history determination routine executed by the CPU of the ECU shown in FIG. 1.

FIG. 5 is a flowchart illustrating an acceleration suppression control routine executed by the CPU of the ECU shown in FIG. 1.

FIG. 6 is a flowchart illustrating an actuator control routine executed by the CPU of the ECU shown in FIG. 1.

### DETAILED DESCRIPTION

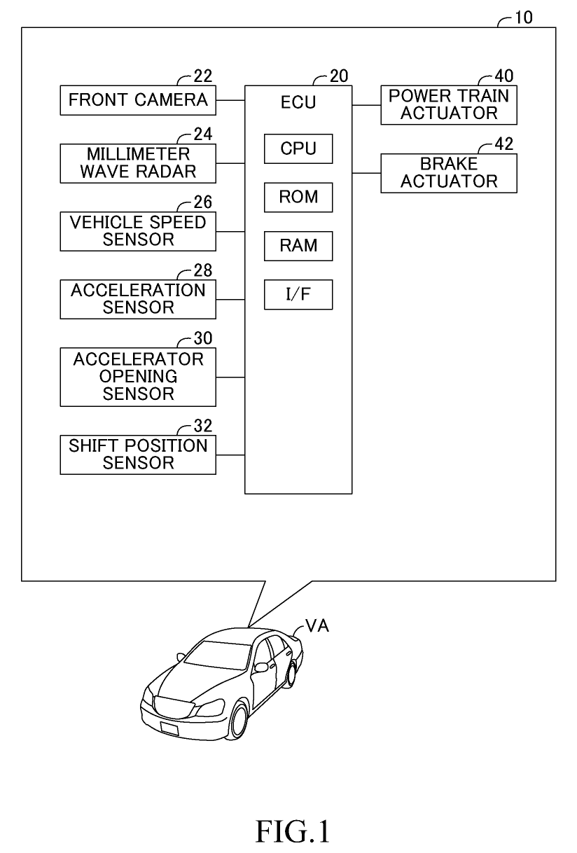

A vehicle control apparatus 10 according to an embodiment of the present disclosure (hereinafter, referred to as "the present apparatus 10") is applied to a vehicle VA and comprises components shown in in FIG. 1. In the present specification, an "ECU 20" is an electronic control unit having a microcomputer as a main component. The ECU 20 is also referred to as a control unit, a controller and a computer. The microcomputer includes a CPU (processor), a ROM, a RAM and an interface (I/F), etc. Functions realized by the ECU 20 may be realized by multiple ECUs.

A front camera 22 captures an image of a scene in front of the vehicle VA to acquire image data. A millimeter wave radar 24 detects an object present in front of the vehicle VA and acquires object data regarding the object. The ECU 20 obtains the image data and the object data respectively from the front camera 22 and the millimeter wave radar 24, and identifies a position of the object with respect to the vehicle VA and a relative speed of the object with respect to the vehicle VA based on the image data and the object data.

A vehicle speed sensor 26 measures a vehicle speed Vs that represents a speed of the vehicle VA. An acceleration sensor 28 measures an acceleration G of the vehicle VA. Note that the acceleration G is a positive value when the vehicle VA accelerates in the traveling direction, and a negative value when the vehicle VA decelerates in the traveling direction. An accelerator opening sensor 30 measures an accelerator opening AP that represents an operation amount (depression amount) of an accelerator pedal (an acceleration operator) of the vehicle VA. The ECU 20 obtains the measurement values from these sensors 26 to 30.

A shift position sensor 32 detects a set position SP of a shift lever (not shown) of the vehicle VA. A driver can set the shift lever to any one of a drive position (D range), a reverse position (R range), a neutral position (N range), and a parking position (P range). The ECU 20 obtains a detection value from the shift position sensor 32 and identifies the set position SP based on the detection value.

A powertrain actuator 40 changes a driving force generated by a drive unit (e.g., an internal combustion engine and/or an electric motor) of the vehicle VA. A brake actuator 42 changes a braking force applied to the vehicle VA.

### Collision Risk Reduction Control

The ECU 20 recognizes the object present in the traveling direction (front) of the vehicle VA based on the image data and the object data. When a collision risk, which represents a possibility that the vehicle VA collides with the object, is high, the ECU 20 executes a collision risk reduction control for reducing the collision risk. The object having a high collision risk may be referred to as a "target object". For example, the collision risk reduction control is a deceleration control for decelerating the vehicle VA. The collision risk reduction control is a type of autonomous driving that supports a driver’s driving operation.

Specifically, the ECU 20 acquires a TTC that represents a time required for the object to collide with the vehicle VA, by dividing a distance between the object and the vehicle VA by the relative speed of the object. TTC stands for Time To Collision. When the TTC is equal to or less than a predetermined threshold time Tth, the ECU 20 determines that the collision risk is high and executes the collision risk reduction control. The TTC can be expressed as an index value representing the collision risk. A smaller TTC represents a higher collision risk.

### Accelerator Override

When an accelerator operation satisfies a predetermined override condition during execution of the collision risk reduction control, the ECU 20 executes an accelerator override that cancels the collision risk reduction control. "To cancel the collision risk reduction control" refers to a concept including stopping and terminating the collision risk reduction control. In the present embodiment, an example will be described in which the ECU 20 terminates the collision risk reduction control when the override condition is satisfied. When the collision risk reduction control is canceled, the vehicle VA accelerates according to the accelerator opening AP.

For example, when at least one of the following conditions A1 and A2 is satisfied, the ECU 20 determines that the accelerator operation satisfies the override condition.

Condition A1: The accelerator opening AP is equal to or greater than a first threshold opening APth1.

Condition A2: The accelerator opening AP is equal to or greater than a second threshold opening APth2, and an operation speed Vap, which represents a depression speed of the accelerator pedal, is equal to or greater than a first threshold speed Vapth1.

Note that the second threshold opening APth2 is set to a value equal to or smaller than the first threshold opening APth1.

### Erroneous Operation Determination

When the accelerator operation satisfies a predetermined erroneous operation condition, the ECU 20 determines that the accelerator operation is an erroneous operation. For example, when all of the following conditions B1 to B3 are satisfied, the ECU 20 determines that the accelerator operation is the erroneous operation.

Condition B1: The accelerator opening AP is equal to or greater than a third threshold opening APth3.

Condition B2: The operation speed Vap is equal to or greater than a second threshold speed Vapth2.

Condition B3: The vehicle speed Vs is equal to or less than a threshold vehicle speed Vsth.

The third threshold opening APth3 is set to a value greater than the first threshold opening APth1. The second threshold speed Vapth2 is set to a value greater than the first threshold speed Vapth1.

Such erroneous operation is highly likely to occur when the driver depresses the accelerator pedal by mistake instead of a brake pedal (not shown). Both the erroneous operation condition and the override condition are determined based on the accelerator opening AP. The erroneous operation condition is set such that it is more difficult to be satisfied than the override condition.

Once the ECU 20 determines that the accelerator operation is the erroneous operation, the ECU 20 continues to determine the accelerator operation as the erroneous operation until the accelerator opening AP becomes equal to or less than a fourth threshold opening APth4. The fourth threshold opening APth4 is set to a value smaller than at least the first threshold opening APth1. Preferably, the fourth threshold opening APth4 is set to a value smaller than the second threshold opening APth2. A period during which the ECU 20 determines that the accelerator operation is the erroneous operation is referred to as an "erroneous operation determination period".

During the erroneous operation determination period, even if the override condition is satisfied, the ECU 20 does not execute the accelerator override (i.e., prohibits the accelerator override) and continues the collision risk reduction control. This prevents the collision risk reduction control from being canceled even when the override condition happens to be satisfied during a period in which the driver is erroneously operating the accelerator pedal.

### Overview of Operation

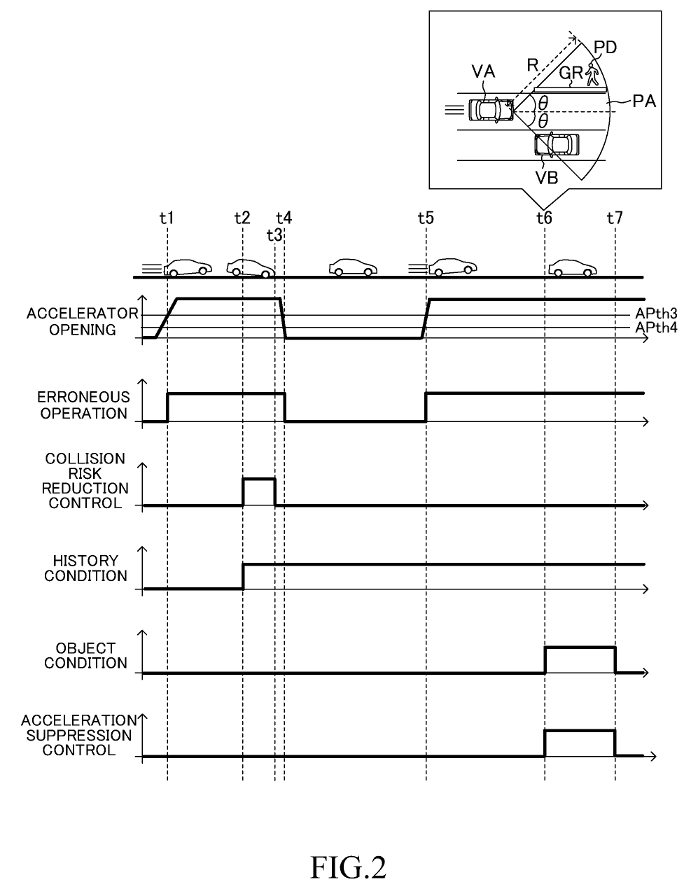

When a history condition is satisfied, the ECU 20 determines whether or not an object condition is satisfied during the erroneous operation determination period. The history condition is satisfied when at least one of the following "execution history and operation history" is stored. The object condition is satisfied when an object is present in a predetermined area PA (see FIG. 2) in the traveling direction of the vehicle VA.

The execution history is a history representing that the collision risk reduction control was executed during the erroneous operation determination period.

The operation history is a history representing that "an operation count N representing the number of times the driver operated the shift lever during the erroneous operation determination period" is equal to or greater than a threshold count Nth.

The execution history and the operation history continue to be stored while the vehicle VA is activated (that is, during one trip in which an ignition is in an ON state). When the vehicle VA is deactivated (i.e., when the ignition is turned OFF) or when the vehicle VA is activated (i.e., when the ignition is turned ON), the execution history and the operation history are erased.

When at least one of the execution history and the operation history is stored (that is, when the history condition is satisfied), it is highly likely that the driver has previously experienced a panic state when erroneously operating the accelerator pedal. Such a driver is also highly likely to cause the vehicle VA to rapidly accelerate when erroneously operating the accelerator pedal.

Accordingly, when the object condition is satisfied during the erroneous operation determination period, the ECU 20 executes an acceleration suppression control for suppressing acceleration of the vehicle VA. In the acceleration suppression control, the ECU 20 suppresses the acceleration G of the vehicle VA such that the acceleration G does not exceed a predetermined limit acceleration Glmt. Even if the driver causes the vehicle VA to rapidly accelerate, the acceleration of the vehicle VA is suppressed. Therefore, it is possible to prevent a situation in which the object present in the traveling direction of the vehicle VA becomes difficult to detect, thereby increasing the possibility that the collision risk reduction control is appropriately executed when the collision risk increases. Furthermore, if the history condition is not satisfied, the acceleration suppression control is not executed, so it is also possible to reduce the possibility that the driver feels discomfort with the acceleration suppression control.

### Example of Operation

An example of the operation of the apparatus 10 will be described with reference to FIG. 2.

At time point t1, all of the above-described conditions B1 to B3 are satisfied, and the ECU 20 determines that the accelerator operation is the erroneous operation.

At time point t2, the risk of collision with the object (not shown) increases, and the ECU 20 starts the collision risk reduction control. In this case, since the collision risk reduction control is executed during the erroneous operation determination period, the ECU 20 stores the execution history. Accordingly, the history condition is satisfied.

At time point t3, the risk of collision with the object (not shown) disappears, and the ECU 20 terminates the collision risk reduction control.

At time point t4, the accelerator opening AP becomes equal to or less than the fourth threshold opening APth4, and the ECU 20 determines that the erroneous accelerator operation ends.

At time point t5, all of the conditions B1 to B3 are satisfied again, and the ECU 20 determines that the accelerator operation is the erroneous operation.

At time point t6, the object (a pedestrian PD, a guardrail GR, or an oncoming vehicle VB) is present in the predetermined area PA, and the object condition is satisfied. In this case, since the object condition is satisfied during the erroneous operation determination period and the history condition has been satisfied, the ECU 20 starts the acceleration suppression control.

At time point t7, no object is present in the predetermined area PA, and the object condition is no longer satisfied. In this case, the ECU 20 terminates the acceleration suppression control.

### Specific Operation

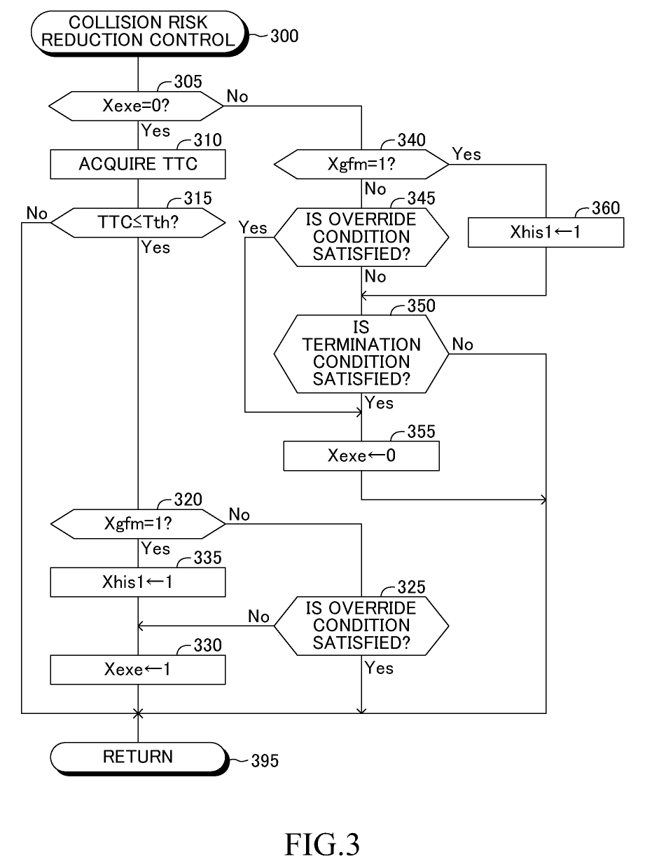

The CPU of the ECU 20 executes routines shown in flowcharts of FIGS. 3 to 6 each time a predetermined time has elapsed.

### Collision Risk Reduction Control Routine

When an appropriate timing comes, the CPU starts a process from step 300 in FIG. 3, and the process proceeds to step 305. At step 305, the CPU determines whether or not an execution flag Xexe is "0".

The execution flag Xexe is set to "1" when the collision risk reduction control is executed, and is set to "0" when the collision risk reduction control is not executed. The execution flag Xexe is also set to "0" in an initialization routine. The initialization routine is executed by the CPU when an ignition key switch (not shown) of the vehicle VA is changed from an OFF position to an ON position (that is, when the vehicle VA is activated).

When the execution flag Xexe is "0", the CPU makes a "Yes" determination at step 305 and executes step 310 and step 315.

Step 310: The CPU obtains the image data and the object data, and acquires the TTC of each object based on the image data and the object data.

Step 315: The CPU determines whether or not the TTC is equal to or less than the threshold time Tth.

When the TTC is greater than the threshold time Tth, the CPU makes a "No" determination at step 315, and the process proceeds to step 395. At step 395, the CPU terminates the present routine tentatively.

When the TTC is equal to or less than the threshold time Tth, the CPU makes a "Yes" determination at step 315, and the process proceeds to step 320. At step 320, the CPU determines whether or not an erroneous operation flag Xgfm is "1". The erroneous operation flag Xgfm is set to "1" when the accelerator operation is determined to be the erroneous operation, and is set to "0" when the accelerator operation is determined not to be the erroneous operation. The erroneous operation flag Xgfm is set to "0" in the initialization routine.

When the erroneous operation flag Xgfm is "0", the CPU makes a "No" determination at step 320, and the process proceeds to step 325. At step 325, the CPU determines whether or not the override condition is satisfied.

When the override condition is not satisfied, the CPU makes a "No" determination at step 325, and the process proceeds to step 330. At step 330, the CPU sets the execution flag Xexe to "1". Thereafter, the process proceeds to step 395.

On the other hand, when the override condition is satisfied, the CPU makes a "Yes" determination at step 325, and the process proceeds to step 395 without executing step 330. Therefore, even if the TTC becomes equal to or less than the threshold time Tth, the collision risk reduction control is not be started when the override condition is satisfied.

If the erroneous operation flag Xgfm is "1" when the process proceeds to step 320, the CPU makes a "Yes" determination at step 320, and the process proceeds to step 335. At step 335, the CPU sets an execution history flag Xhis1 to "1". The execution history flag Xhis1 is set to "1" when the execution history is stored, and is set to "0" when the execution history is not stored. The execution history flag Xhis1 is set to "0" in the initialization routine (that is, the execution history is erased when the vehicle VA is activated).

On the other hand, if the execution flag Xexe is set to "1" when the process proceeds to step 305, the CPU determines "No" in step 305 and proceeds to step 340. At step 340, the CPU determines whether or not the erroneous operation flag Xgfm is "1".

When the erroneous operation flag Xgfm is "0", the CPU makes a "No" determination at step 340, and the process proceeds to step 345. At step 345, the CPU determines whether or not the override condition is satisfied.

When the override condition is not satisfied, the CPU makes a "No" determination at step 345, and the process proceeds to step 350. At step 350, the CPU determines whether or not a termination condition for the collision risk reduction control is satisfied. Specifically, the termination condition is satisfied when the collision risk with the object having the TTC less than or equal to the threshold time Tth is no longer present, or when the vehicle VA stops.

When the termination condition is not satisfied, the CPU makes a "No" determination at step 350, and the process proceeds to step 395. On the other hand, when the termination condition is satisfied, the CPU makes a "Yes" determination at step 350, and the process proceeds to step 355. At step 355, the CPU sets the execution flag Xexe to "0". Thereafter, the process proceeds to step 395.

If the override condition is satisfied when the process proceeds step 345, the CPU makes a "Yes" determination at step 345, and the process proceeds to step 355. Therefore, when the override condition is satisfied during the execution of the collision risk reduction control, the execution flag Xexe is set to "0", and the collision risk reduction control is terminated. This is referred to as the accelerator override.

If the erroneous operation flag Xgfm is "1" when the process proceeds to step 340, it represents that the collision risk reduction control was executed during the erroneous operation determination period, and thus, the execution history is stored. In this case, the CPU makes a "Yes" determination at step 340, and the process proceeds to step 360. At step 360, the CPU sets the execution history flag Xhis1 to "1".

Thereafter, the process proceeds to step 350. As a result, the CPU does not determine whether or not the override condition is satisfied during the erroneous operation determination period. Therefore, the CPU prohibits the accelerator override during that period.

### Operation History Determination Routine

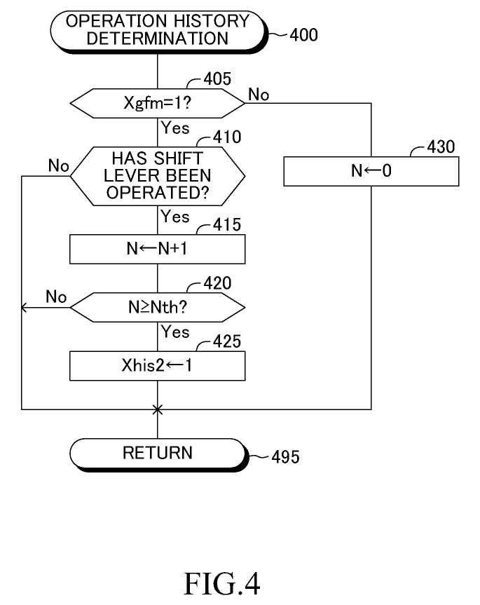

When an appropriate timing comes, the CPU starts a process from step 400 in FIG. 4, and the process proceeds to step 405. At step 405, the CPU determines whether or not the erroneous operation flag Xgfm is "1".

When the erroneous operation flag Xgfm is "1", the CPU makes a "Yes" determination at step 405, and the process proceeds to step 410. At step 410, the CPU determines whether or not the shift lever has been operated. Specifically, the CPU determines that the shift lever has been operated when the setting position SP identified based on the detection value of the shift position sensor 32 differs from the "setting position SP at the time this routine was last executed".

When the shift lever has not been operated, the CPU makes a "No" determination at step 410, and the process proceeds to step 495. At step 495, the CPU terminates the present routine tentatively.

On the other hand, when the shift lever has been operated, the CPU makes a "Yes" determination at step 410, and executes step 415 and step 420.

Step 415: The CPU add "1" to the operation count N, which represents the number of times the shift lever has been operated during the erroneous operation determination period.

Step 420: The CPU determines whether or not the operation count N is equal to or greater than the threshold count Nth.

When the operation count N is less than the threshold count Nth, the CPU makes a "No" determination at step 420, and the process proceeds to step 495.

On the other hand, when the operation count N is equal to or greater than the threshold count Nth, it means that there is the operation history. In this case, the CPU makes a "Yes" determination at step 420, and the process proceeds to step 425.At step 425, the CPU sets an operation history flag Xhis2 to "1". The operation history flag Xhis2 is set to "1" when the operation history is stored, and is set to "0" when the operation history is not stored. The operation history flag Xhis2 is set to "0" in the initialization routine (that is, the operation history is erased when the vehicle VA is activated). Thereafter, the process proceeds to step 495.

If the erroneous operation flag Xgfm is "0" when the process proceeds to step 405, the CPU makes a "No" determination at step 405, and the process proceeds to step 430.At step 430, the CPU sets the operation count N to "0". Thereafter, the process proceeds to step 495.

### Acceleration Suppression Control Routine

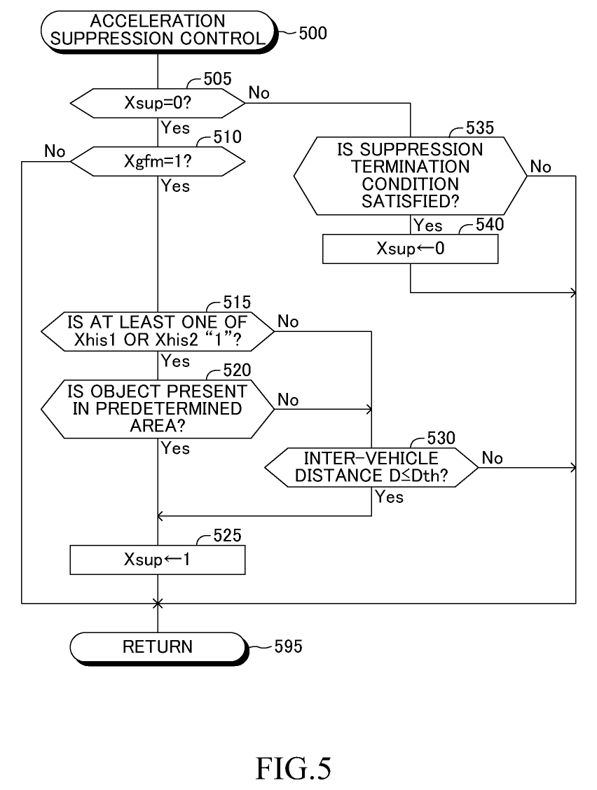

When an appropriate timing comes, the CPU starts a process from step 500 in FIG. 5, and the process proceeds to step 505. At step 505, the CPU determines whether or not a suppression flag Xsup is "0". The suppression flag Xsup is set to "1" when the acceleration suppression control is executed, and is set to "0" when the acceleration suppression control is not executed. The suppression flag Xsup is set to "0" in the initialization routine.

When the suppression flag Xsup is "0", the CPU makes a "Yes" determination at step 505, and the process proceeds to step 510. At step 510, the CPU determines whether or not the erroneous operation flag Xgfm is "1".

When the erroneous operation flag Xgfm is "0", the CPU makes a "No" determination at step 510, and the process proceeds to step 595. At step 595, the CPU terminates the present routine tentatively.

On the other hand, when the erroneous operation flag Xgfm is "1", the CPU makes a "Yes" determination at step 510, and the process proceeds to step 515. At step 515, the CPU determines whether or not at least one of the execution history flag Xhis1 or the operation history flag Xhis2 is "1".

When at least one of the execution history flag Xhis1 or the operation history flag Xhis2 is "1", the CPU makes a "Yes" determination at step 515, and the process proceeds to step 520. At step 520, the CPU determines whether or not the object is present in the predetermined area PA in the traveling direction of the vehicle VA.

As one example, as shown in FIG. 2, the predetermined area PA is set in a sector shape. The central angle of this sector shape is "2θ," and the radius is "R". The predetermined area PA is set such that a centerline dividing the central angle in half aligns with the longitudinal axis of the vehicle VA. For example, "θ" is 50 degrees, and R is 200 meters. FIG. 2 illustrates an example where the predetermined area PA is set in front of the vehicle VA when the traveling direction is forward; however, when the traveling direction is rearward, the predetermined area PA is set behind the vehicle VA.

When the object is present in the predetermined area PA, the object condition is satisfied. As a result, since the object condition is satisfied during the erroneous operation determination period after the history condition is satisfied, the acceleration suppression control is executed. In this case, the CPU makes a "Yes" determination at step 520, and the process proceeds to step 525. At step 525, the CPU sets the suppression flag Xsup to "1". Thereafter, the process proceeds to step 595.

If both the execution history flag Xhis1 and the operation history flag Xhis2 are "0" when the process proceeds to step 515, the history condition is not satisfied. In this case, the CPU makes a "No" determination at step 515, and the process proceeds to step 530. If no object is present in the predetermined area PA when the process proceeds to step 520, the object condition is not satisfied. In this case, the CPU makes a "No" determination at step 520, and the process proceeds to step 530.

At step 530, the CPU determines whether or not an inter-vehicle distance D between the vehicle VA and a preceding vehicle is less than or equal to a threshold distance Dth. The preceding vehicle refers to another vehicle that is located on the same lane as the vehicle VA and within a predetermined distance in the traveling direction of the vehicle VA.

When the inter-vehicle distance D is less than or equal to the threshold distance Dth, the CPU makes a "Yes" determination at step 530, and the process proceeds to step 525. On the other hand, when no preceding vehicle is present, or when the inter-vehicle distance D is greater than the threshold distance Dth, the CPU makes a "No" determination at step 530, and the process proceeds to step 595.

On the other hand, if the suppression flag Xsup is "1" when the process proceeds to step 505, the CPU makes a "No" determination at step 505, and the process proceeds to step 535. At step 535, the CPU determines whether or not a termination condition for the acceleration suppression control (hereinafter referred to as a "suppression termination condition") is satisfied. When an object is no longer present in the predetermined area PA, or when the erroneous operation flag Xgfm becomes "0", the CPU determines that the suppression termination condition is satisfied.

When the suppression termination condition is not satisfied, the CPU makes a "No" determination at step 535, and the process proceeds to step 595. On the other hand, when the suppression termination condition is satisfied, the CPU makes a "Yes" determination at step 535, and the process proceeds to step 540. At step 540, the CPU sets the suppression flag Xsup to "0". Thereafter, the process proceeds to step 595.

### Actuator Control Routine

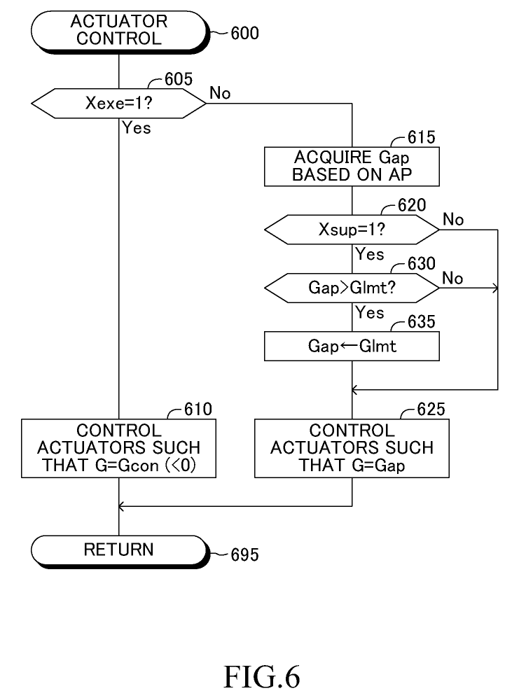

When an appropriate timing comes, the CPU starts a process from step 600 in FIG. 6, and the process proceeds to step 605. At step 605, the CPU determines whether or not the execution flag Xexe is "1".

When the execution flag Xexe is "1", the CPU makes a "Yes" determination at step 605, and the process proceeds to step 610. At step 610, the CPU controls the powertrain actuator 40 and the brake actuator 42 such that the acceleration G matches a predetermined control acceleration Gcon. The control acceleration Gcon is preset to a negative value. Accordingly, when the execution flag Xexe is "1", the collision risk reduction control for decelerating the vehicle VA is executed. Thereafter, the process proceeds to step 695. At step 695, the CPU terminates the present routine tentatively.

When the execution flag Xexe is "0", the CPU makes a "No" determination at step 605, and executes step 615 and step 620.

Step 615: The CPU acquires an operation acceleration Gap based on the accelerator opening AP. Note that the operation acceleration Gap increases as the accelerator opening AP increases.

Step 620: The CPU determines whether or not the suppression flag Xsup is "1".

When the suppression flag Xsup is "0", the CPU makes a "No" determination at step 620, and the process proceeds to step 625. At step 625, the CPU controls the powertrain actuator 40 and the brake actuator 42 such that the acceleration G matches the operation acceleration Gap. Thereafter, the process proceeds to step 695.

If the suppression flag Xsup is "1" when the process proceeds to step 620, the CPU makes a "Yes" determination at step 620, and the process proceeds to step 630. At step 630, the CPU determines whether or not the operation acceleration Gap is greater than the predetermined limit acceleration Glmt.

When the operation acceleration Gap is equal to or less than the limit acceleration Glmt, the CPU makes a "No" determination at step 630, and the process proceeds to step 625.

On the other hand, when the operation acceleration Gap is greater than the limit acceleration Glmt, the CPU makes a "Yes" determination at step 630, and the process proceeds to step 635. At step 635, the CPU sets the operation acceleration Gap to the limit acceleration Glmt. Thereafter, the process proceeds to step 625. As a result, when the suppression flag Xsup is "1", the acceleration of the vehicle VA is suppressed such that the operation acceleration Gap does not exceed the limit acceleration Glmt.

As described above, the present apparatus 10 executes the acceleration suppression control when the history condition is satisfied and the object condition becomes satisfied during the erroneous operation determination period. As a result, since the acceleration of the vehicle VA is suppressed, the present apparatus 10 can increase the possibility of appropriately executing the collision risk reduction control. Furthermore, since the present apparatus 10 does not execute the acceleration suppression control when the history condition is not satisfied, it can also reduce the possibility that the driver feels discomfort with the acceleration suppression control.

### First Modified Example

The ECU 20 may, instead of executing the deceleration control, cause a warning display element to be displayed on a display (not shown) and/or emit a warning sound from a speaker (not shown). The display may be, for example, a multi-information display. The warning display element is a display element that notifies the driver that there is a high risk of collision with the object. Note that the ECU 20 may also display the warning display element and/or emit the warning sound in addition to executing the deceleration control.

### Second Modified Example

The operation count N represents the number of times the shift lever has been operated during the single erroneous operation determination period, but it is not limited to this. For example, the operation count N may represent the total number of times the shift lever is operated during the erroneous operation determination period in the time from when the vehicle VA is activated to when the vehicle VA is deactivated. In this case, when the erroneous operation flag Xgfm is "0", step 430 shown in FIG. 4 is not executed. The operation count N is set to "0" in the initialization routine or when the vehicle VA is deactivated.

### Third Modified Example

The CPU may determine that the execution history (that is, the CPU may set the execution history flag Xhis1 to "1") is stored when the number of times the collision risk reduction control is executed during the erroneous operation determination period is equal to or greater than a threshold number.

### Fourth Modified Example

The execution history and the operation history may be erased when the vehicle VA is deactivated. That is, when the vehicle VA is deactivated, the execution history flag Xhis1 and the operation history flag Xhis2 may be set to "0". Furthermore, when the driver performs a predetermined operation while the vehicle VA is activated, the execution history and operation history may also be erased.

### Fifth Modified Example

Even if the accelerator operation is not the erroneous operation, the acceleration suppression control may be executed when both the history condition and the object condition are satisfied.

### Sixth Modified Example

In the above embodiment, an example is described in which the present disclosure is applied when the traveling direction of the vehicle VA is forward. However, the present disclosure is also applicable when the traveling direction of the vehicle VA is rearward.

The present apparatus 10 can be applied to (or installed in/on) an engine vehicle, a hybrid electric vehicle (HEV), a plug-in hybrid electric vehicle (PHEV), a fuel cell electric vehicle (FCEV), and a battery electric vehicle (BEV).

What is claimed is:

1. A vehicle control apparatus that executes a collision risk reduction control for reducing a collision risk, when a target object having a high collision risk of colliding with a vehicle is present in a traveling direction of the vehicle,
wherein the vehicle control apparatus is configured to:
execute an accelerator override that cancels the collision risk reduction control when an accelerator operation by a driver satisfies a predetermined override condition during execution of the collision risk reduction control;
determine that the accelerator operation is an erroneous operation when the accelerator operation satisfies a predetermined erroneous operation condition;
not execute the accelerator override even if the accelerator operation satisfies the override condition during an erroneous operation determination period representing a period during which the accelerator operation is determined to be the erroneous operation; and
execute an acceleration suppression control for suppressing acceleration of the vehicle when both a history condition and an object condition are satisfied,
wherein, the history condition is satisfied when at least one of an execution history representing that the collision risk reduction control was executed during the erroneous operation determination period and an operation history representing that the number of times the driver operated a shift lever during the erroneous operation determination period is equal to or greater than a threshold number is stored,
wherein, the object condition is satisfied when an object is present in a predetermined area in the traveling direction.

2. The vehicle control apparatus according to claim 1,
wherein the vehicle control apparatus is configured to execute the acceleration suppression control when the object condition is satisfied in the erroneous operation determination period after the history condition has been satisfied.

3. The vehicle control apparatus according to claim 1,
wherein the vehicle control apparatus is configured to:
continue to store the execution history and the operation history while the vehicle is activated; and
erase the execution history and the operation history when the vehicle is deactivated or when the vehicle is activated.
